(19) United States
(12) Patent Application Publication
(10) Pub. No.: US 2003/0199407 A1
(43) Pub. Date: Oct. 23, 2003

(54) Composition of a resist stripper using electrolytic material with high equivalent conductivity in an aqueous solution

(75) Inventors: Ho Sung Choi, Anyang-City (KR); Ji Hong Kim, Pyungtaek-City (KR); Tae Gewn Kim, Pyungtaek-City (KR); Sang Hyeuk Yeo, Ohsan-City (KR); Hae Sung Park, Ohsan-City (KR)

Correspondence Address: John S. Egbert, Harrison & Egbert, 7th Floor, 412 Main Street, Houston, TX, 77002, US

(73) Assignee: DUKSUNG Co., Ltd., Hwasung-City (KR)

(21) Appl. No.: 10/189,226

(22) Filed: Jul. 5, 2002

(30) Foreign Application Priority Data
Apr. 18, 2002 (KR) 2002-0021242

(51) Int. Cl. C11D 1/00

(52) U.S. Cl. 510/176; 510/178

(57) ABSTRACT

Disclosed is a composition of resist stripper, which is advantageous in light of excellent strippability for residual resists after etching and ashing processes, and superior corrosion resistance to a metal film or a substrate formed with an inorganic material film. The stripping composition comprises 0.5-25 wt % of an electrolytic material having an equivalent conductivity of 300 Ω⁻¹cm²equiv⁻¹ or higher in 0.001 N aqueous solution at 18° C., 60.0-99.4 wt % of water and 0.1-25.0 wt % of a corrosion inhibitor.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention is directed to a composition of resist stripper, which has excellent strippability for a photoresist used in the production of semiconductor devices, liquid crystal displays and the like, and for the residual photoresist remaining after etching and ashing processes, with providing superior corrosion resistance to a metal film or a substrate formed with a film of various inorganic materials.

The composition of resist stripper of the present invention is high in stripping effect for metal line patterns as well as hole patterns.

### BACKGROUND OF THE INVENTION

In the manufacture of semiconductor devices or liquid crystal displays, there has been employed a process comprising laminating multiple metal and insulating layers on a substrate made of silicon or glass, and etching such metal layers or insulating layers to form metal line patterns or hole patterns.

As typical stripping compositions, use has been made of hydroxyl amine- (ACT-935 supplied from Ashland Inc., or EKC-270 obtained from EKC Co., Ltd.), tetramethylammonium hydroxide-, ammonium fluoride- (EKC-640 obtained from EKC Co., Ltd.) based stripping compositions, and general organic type stripping compositions. However, such compositions suffer from the disadvantages of not sufficiently removing the resist remaining in 0.25 μm hole patterns having the metal film formed with titanium compounds, such as titanium (Ti) or titanium nitride (TiN), in their lower portions, and also damaging the metal film or the substrate formed with inorganic film.

### BRIEF SUMMARY OF THE INVENTION

It is an object of the present invention to provide a composition of resist stripper, which is advantageous in light of excellent strippability for a residual resist remaining after undergoing etching and ashing, and providing corrosion resistance to a metal film or a substrate formed with a film made of various inorganic materials. More specifically, the present invention provides an aqueous stripping composition for resists useful in removal of a photoresist remaining in hole patterns by use of an electrolytic material having high equivalent conductivity in an aqueous solution.

In general, hole patterns have a photoresist or residue thereof remaining after etching and ashing that is not sufficiently removed with conventional stripping compositions, compared with the removal of resist from metal line patterns. Thus, the intensive and thorough research on resist strippers, carried out by the present inventors aiming to avoid the problems encountered in the prior arts, resulted in the finding that, when an electrolytic material having high equivalent conductivity in aqueous solutions is used as one component of the stripping composition, the residual resist of hole patterns and metal line patterns can be easily removed through redox reaction.

### BRIEF DESCRIPTION OF THE SEVERAL VIEWS OF THE DRAWINGS

FIG. 1A is a scanning electron microscopic photograph showing the extent of stripping of a residual resist after a resist of hole patterns is subjected to stripping treatment with a composition of Example 1.

FIG. 1B is a scanning electron microscopic photograph showing the extent of stripping of a residual resist after a resist of hole patterns is subjected to stripping treatment with a composition of Comparative Example 1.

FIG. 2A is a scanning electron microscopic photograph showing the extent of stripping of a residual resist after a resist of metal line patterns is subjected to stripping treatment with a composition of Example 1.

FIG. 2B is a scanning electron microscopic photograph showing the extent of stripping of a residual resist after a resist of metal line patterns is subjected to stripping treatment with a composition of Comparative Example 1.

FIG. 3A is a scanning electron microscopic photograph showing the extent of corrosion of a metal layer after a resist of metal line patterns is subjected to stripping treatment with a composition of Example 1.

FIG. 3B is a scanning electron microscopic photograph showing the extent of corrosion of a metal layer after a resist of metal line patterns is subjected to stripping treatment with a composition of Comparative Example 1.

FIG. 4A is a scanning electron microscopic photograph showing the extent of stripping of a residual resist and the extent of corrosion of a silicon based inorganic wall face after a resist of hole patterns is subjected to stripping treatment with a composition of Example 1.

FIG. 4B is a scanning electron microscopic photograph showing the extent of stripping of a residual resist and the extent of corrosion of a silicon based inorganic wall face after a resist of hole patterns is subjected to stripping treatment with a composition of Comparative Example 1.

FIG. 5A is a scanning electron microscopic photograph showing the extent of stripping of a residual resist and the extent of corrosion of a silicon based inorganic wall face after a resist of hole patterns is subjected to stripping treatment with a composition of Example 6.

FIG. 5B is a scanning electron microscopic photograph showing the extent of stripping of a residual resist and the extent of corrosion of a silicon based inorganic wall face after a resist of hole patterns is subjected to stripping treatment with a composition of Comparative Example 6.

### DETAILED DESCRIPTION OF THE INVENTION

The present invention pertains to an aqueous stripping composition which is employed to remove a resist remaining after etching and ashing, useful in the production of semiconductor devices, liquid crystal displays and the like. Particularly, such composition is excellent in strippability and corrosion resistance for hole patterns having the lower film portions formed with titanium compounds, such as titanium (Ti) or titanium nitride (TiN).

The inventive stripping composition consists of 0.5-25 wt % of an electrolytic material having an equivalent conductivity of 300 Ω⁻¹cm²equiv⁻¹ or more in 0.001 N weak solution at 18° C., 60.0-99.4 wt % of water and 0.1-25.0 wt % of a corrosion inhibitor.

The electrolytic material having the equivalent conductivity of 300 Ω⁻¹cm²equiv⁻¹ or more in 0.001 N weak solution, is enumerated by, for example, hydrochloric acid, sulfuric acid, nitric acid or perchloric acid. Such material can be used alone or in mixtures thereof.

Examples of the corrosion inhibitor include aromatic hydroxy compounds, such as catechol and pyrogallol; benzotriazole-based compounds, such as benzotriazole, 1,2,3-benzotriazole, 1-hydroxy benzotriazole, 1-methoxy benzotriazole, 1-(2,3-dihydroxy propyl) benzotriazole; acetylene alcohols, such as 2-butyne-1,4-diol; carboxylic group containing organic compounds, such as formic acid, phthalic acid, benzoic acid and salicylic acid. In addition, use may be made of a reaction product obtained by reacting alkyl acetoacetate or acetic acid with fatty acid amine, in which alkyl acetoacetate comprises methyl acetoacetate or ethyl acetoacetate, and acetic acid may be used in an anhydride form.

The fatty acid amine is exemplified by monoethanolamine, isopropanolamine, diethanolamine, dimethyl amino ethanol and dimethyl ethanolamine.

Alkyl acetoacetate or acetic acid is reacted with fatty acid amine at room temperature, without additional heating, to produce a viscous reaction product having low volatility.

A better understanding of the present invention may be obtained in light of the following example which is set forth to illustrate, but is not to be construed to limit the present invention.

### EXAMPLE

In the following Table 1 is shown an electrolytic material widely used as a stripper composition, having high equivalent conductivity in an aqueous solution.

TABLE 1
Conductivity of Electrolyte in Aqueous Solution (18° C.)
Conductivity (unit: •⁻¹cm²equiv⁻¹)

Concentration (N)

| Electrolyte | 0.001 | 0.01 | 0.1 | 1.0 |
|---|---|---|---|---|
| HCl | 377 | 370 | 351 | 301 |
| HClO₄ (25° C.) | 413 | 402 | 386 | — |
| HF | — | 60 | 31.3 | 25.7 |
| HNO₃ | 375 | 368 | 350 | 310 |
| 1/2 H₂SO₄ | 361 | 308 | 225 | 198 |
| NH₄F | — | — | — | 65.7 |

Note: N: normal cone.

In the above Table 1, H₂SO₄ is represented by ½ H₂SO₄ because it is a bivalent acid.

### Examples 1-12

The resist stripper of the present invention was prepared according to the composition presented in Table 2, below, and assayed for strippability thereof according to a manner as described below. For comparison, conventional stripping compositions (comparative examples 1-6) were used and assayed for their function. In Comparative Example 1, a stripping composition supplied from Ashland Inc., U.S., under a trade name of ACT-935, was used.

Assay for strippability and corrosion resistance for 0.25 μm hole pattern having a lower film portion formed with titanium compound

A commercially available positive type resist for KrF was applied on 8 inch silicon (Si) wafer at 1.6 μm thickness, heat-treated at 100° C. for 90 seconds and 120° C. for 90 seconds, and subjected to a series of processes of photolithography, etching and ashing, to give 0.25 μm hole patterns formed wafer. A test piece of the wafer, 15×15 mm, was immersed into a stripper solution at 70° C. for 10 minutes, rinsed with ultra pure water for 3 minutes, and dried with an air conditioner. Thereafter, the extent of stripping of the resist from within the hole patterns, and the extent of corrosion of an inorganic substrate (wall face formed with silicon compounds of the hole) were observed by a scanning electron microscope (hereinafter, referred to as SEM) (S-4300, HITACH, Ltd.). The results are presented in Table 3, below.

Assay for strippability and corrosion resistance for semiconductor metal line comprising Ti/Al/TiN

After undergoing the processes of photolithography, etching and ashing in the same manner as in the above assay for hole patterns, the wafer test piece having metal line patterns formed with Ti/Al/TiN was immersed in a stripper solution at 35° C. for 10 minutes, rinsed with ultra pure water and dried under an air conditioner. Then, the extent of stripping of the resist on the patterns and the extent of corrosion of the metal line were observed by SEM. The results are given in Table 3, below.

TABLE 2
Composition of Stripper Solution

| | | | | | | | | | | | | (unit: wt %) | |
|---|---|---|---|---|---|---|---|---|---|---|---|---|---|
| | | | | | | | | | Ultra | | | | |
| Ex. | | | | | | | | | Pure | AA | MAA | | |
| No. | HF | HNO₃ | H₂SO₄ | NH₄F | HClO₄ | HA | TMAH | DMAc | Water | Prod. | Prod. | BTA | Catechol |
| 1 | | | 3.5 | | | | | | 86.5 | 10 | | | |
| 2 | | | 3.5 | 0.1 | | | | | 81.4 | 15 | | | |
| 3 | | | 3.5 | 0.2 | | | | | 76.3 | 10 | | | |
| 4 | | | 15 | | | | | | 75 | 10 | | | |
| 5 | | | | | 3.5 | | | | 93.5 | 3 | | | |
| 6 | | | | | 5 | | | | 80 | | 15 | | |
| 7 | | | 5 | | 5 | | | | 88 | 2 | | | |
| 8 | | | 5 | 0.1 | | | | | 84.9 | 10 | | | |
| 9 | | | 5 | | 3.5 | | | | 81.5 | 10 | | | |
| 10 | | | | | 5 | | | | 90 | | | | 5 |
| 11 | | 3 | | | 3 | | | | 90 | | | 4 | |
| 12 | | 2 | | | 3 | | | | 82 | 3 | | | |
| C. Ex. 1 | | | | | | | | | | | | | |
| (ACT-935) | | | | | | | | | | | | | |
| C. Ex. 2 | | | | | | 15 | | | 75 | | | | 10 |
| C. Ex. 3 | | | | 2 | | | 3 | | 85 | | | | 10 |
| C. Ex. 4 | 2 | | | | | | 2 | | 96 | | | | |
| C. Ex. 5 | | | | 0.2 | | 15 | | 79.8 | | | | | 5 |
| C. Ex. 6 | 1.5 | | | 2 | | | | | 86.5 | | | | 10 |

Note:
HF: hydrofluoric acid,
HNO₃: nitric acid,
H₂SO₄: sulfuric acid,
NH₄F: ammonium fluoride,
HClO₄: perchloric acid (used in 70 wt % aqueous solution form),
HA: hydroxyl amine,
TWAH: tetramethyl amnonium hydroxide (used in 25 wt % aqueous solution form)
DMAc: dimethyl acetoamide,
BTA: benzotriazole,
AA Prod.: reaction product of acetic acid and fatty acid amine,
MAA Prod. : a reaction product of methyl acetloacetate and fatty acid amine

TABLE 3
Assay for Strippability and Corrosion Resistance of Stripper
Solution

| | | | Corrosion Resistance | | |
|---|---|---|---|---|---|
| | | | 0.25 μm | | |
| | Strippability | | Hole Pattern | | |
| | 0.25 μm | | Inorganic | Lower | |
| | Hole | Metal Line | Substrate | Film | Metal Line |
| Ex. No. | Pattern | (Ti/Al/TiN) | (Si-compound) | (TiN) | (Ti/Al/TiN) |
| 1 | ◯ | ⊚ | ⊚ | ⊚ | ⊚ |
| 2 | ◯ | ⊚ | ◯ | ⊚ | ⊚ |
| 3 | ◯ | ⊚ | ◯ | ⊚ | ⊚ |
| 4 | ⊚ | ⊚ | ⊚ | ⊚ | ⊚ |
| 5 | ⊚ | ⊚ | ⊚ | ⊚ | ⊚ |
| 6 | ⊚ | ⊚ | ⊚ | ⊚ | ⊚ |
| 7 | ⊚ | ⊚ | ⊚ | ⊚ | ⊚ |
| 8 | ◯ | ⊚ | ◯ | ⊚ | ⊚ |
| 9 | ◯ | ⊚ | ⊚ | ⊚ | ⊚ |
| 10 | ⊚ | ⊚ | ⊚ | ⊚ | ⊚ |
| 11 | ⊚ | ⊚ | ⊚ | ⊚ | ⊚ |
| 12 | ⊚ | ⊚ | ⊚ | ⊚ | ⊚ |
| C. Ex. 1 | Δ | ⊚ | ⊚ | ⊚ | ⊚ |
| C. Ex. 2 | Δ | ⊚ | ⊚ | ⊚ | ⊚ |
| C. Ex. 3 | Δ | Δ | ◯ | ⊚ | Δ |
| C. Ex. 4 | ◯ | ◯ | Δ | ⊚ | Δ |
| C. Ex. 5 | Δ | ⊚ | ◯ | ⊚ | Δ |
| C. Ex. 6 | ◯ | ⊚ | Δ | ◯ | Δ |

Note:
Strippability: ⊚ excellent, ◯ good, Δ poor
Corrosion Resistance: ⊚ excellent, ◯ good, Δ poor

As shown in the above Table 3, it can be seen that the compositions of the examples 1-12 are excellent in strippability, and corrosion resistance to the silicon-based substrate or metal film.

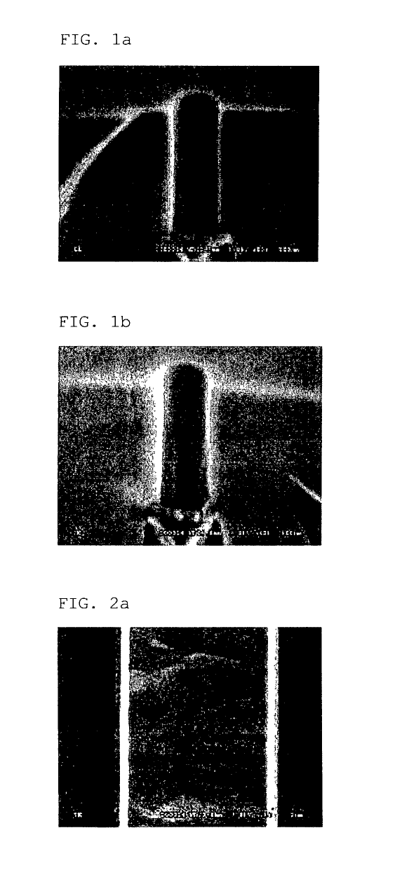

With reference to FIG. 1A, there is shown a photograph showing the extent of stripping of the residual resist remaining after the resist in hole patterns is stripped with the composition of the example 1, taken by a scanning electron microscope.

In FIG. 1B is shown a photograph showing the extent of stripping of the residual resist remaining after the resist in hole patterns is stripped with the composition of the comparative example 1, taken by a scanning electron microscope.

As shown in FIG. 1A, very small amounts of the resist remain in the hole patterns, while considerable amounts of the resist remain in the hole patterns shown in FIG. 1B.

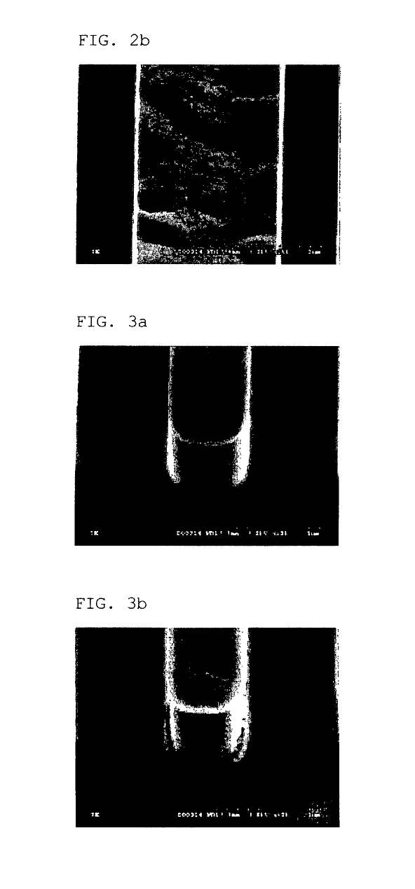

FIG. 2A shows a photograph showing the extent of stripping of the resist remaining after the resist of the metal line is stripped with the composition of the example 1, taken by a scanning electron microscope.

In FIG. 2B, a photograph showing the extent of stripping of the residual resist after the resist of the metal line is stripped with the composition of the comparative example 1 is shown, taken by a scanning electron microscope.

As can be seen in FIG. 2A, the resist is completely removed from the metal line, and thus the metal face is exposed. Meanwhile, from FIG. 2B, it can be seen that the resist partially remains (white portion in figure).

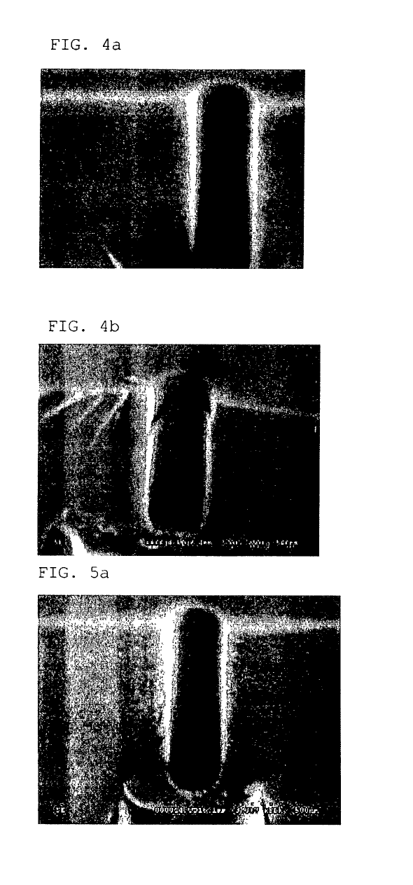

FIG. 3A is a photograph showing the extent of corrosion of the metal layer after the resist of the metal line is stripped with the composition of the example 1, taken by a scanning electron microscope.

FIG. 3B shows a photograph showing the extent of corrosion of the metal layer after the resist of the metal line is stripped with the composition of the comparative example 1, taken by a scanning electron microscope.

As seen in FIG. 3A, the metal layer of the metal line is resistant to corrosion, while from FIG. 3B, it can be seen that the metal layer of the metal line is corroded.

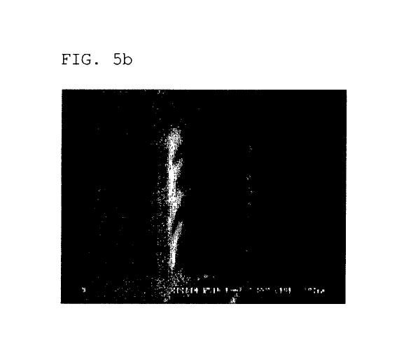

FIG. 4A is a photograph showing the extent of stripping of the residual resist and the extent of corrosion of the silicon based inorganic wall face after the resist of the hole patterns is stripped with the composition of the example 1, taken by a scanning electron microscope.

Referring to FIG. 4B, there is shown a photograph illustrating the extent of stripping of the remaining resist and the extent of corrosion of the silicon based inorganic wall face after the resist of the hole patterns is stripped with the composition of the comparative example 1, taken by a scanning electron microscope.

Referring to FIG. 5A, there is shown a photograph presenting the extent of stripping of the remaining resist and the extent of corrosion of the silicon based inorganic wall face after the resist of the hole patterns is stripped with the composition of the example 6, taken by a scanning electron microscope.

FIG. 5B shows a photograph illustrating the extent of stripping of the residual resist and the extent of corrosion of the silicon based inorganic wall face after the resist of the hole patterns is stripped with the composition of the comparative example 6, taken by a scanning electron microscope.

From FIGS. 4A and 5A, it can be seen that the resist in the hole patterns is completely removed and the silicon based inorganic wall face is not corroded. However, as can be seen in FIGS. 4B and 5B, the silicon based inorganic wall face is corroded.

As described above, the composition of resist stripper of the present invention has the advantages in terms of excellent strippability for the residual resists remaining after the resists are subjected to etching and ashing, and providing corrosion resistance to metal films or substrates formed with inorganic material film.

In particular, the inventive stripping composition can be usefully employed to strip the residual resist in 0.25 μm hole patterns having the metal film formed with titanium compounds, such as titanium or titanium nitride, at their lower portions.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

We claim:

1. A composition of resist stripper, comprising 0.5-25 wt % of an electrolytic material having an equivalent conductivity of 300 Ω⁻¹cm²equiv⁻¹ or higher in 0.001 N aqueous solution at 18° C., 60.0-99.4 wt % of water and 0.1-25.0 wt % of a corrosion inhibitor.

2. The composition as defined in claim 1, wherein the electrolytic material having the equivalent conductivity of 300 Ω⁻¹cm²equiv⁻¹ higher in 0.001 N aqueous solution at 18° C., is selected from the group consisting of hydrochloric acid, sulfuric acid, nitric acid, perchloric acid and mixtures thereof.

3. The composition as defined in claim 1, wherein the corrosion inhibitor is selected from the group consisting of catechol, pyrogallol, benzotriazole, 1,2,3-benzotriazole, 1-hydroxy benzotriazole, 1-methoxy benzotriazole, 1-(2,3-dihydroxy propyl) benzotriazole, 2-butyne-1,4-diol, formic acid, phthalic acid, benzoic acid, salicylic acid, or a reaction product of alkyl acetoacetate or acetic acid with fatty acid amine.
